(19) United States
(12) Patent Application Publication
(10) Pub. No.: US 2023/0281185 A1
(43) Pub. Date: Sep. 7, 2023

(54) DEVICE, SYSTEM AND METHOD FOR MODIFYING ELECTRONIC WORKFLOWS

(71) Applicant: MOTOROLA SOLUTIONS, INC., Chicago, IL (US)

(72) Inventors: Yong TIAN, Beijing (CN); Yong PENG, Chicago, IL (US); Dong ZHAO, Beijing (CN); Hai-Qing HU, Beijing (CN); Yu-Yang ZHENG, Beijing (CN); Jun JIANG, Beijing (CN); Xun FEI, Beijing (CN)

(21) Appl. No.: 18/019,123

(22) PCT Filed: Sep. 16, 2020
(86) PCT No.: PCT/CN2020/115664

§ 371 Date: Feb. 1, 2023

(51) Int. Cl. G06F 16/23; G06F 16/2455; G06F 16/2453

(52) U.S. Cl. CPC G06F 16/2365; G06F 16/24542; G06F 16/2455

(57) ABSTRACT

A device, system and method for modifying electronic workflows is provided. An example device: receives, from a user mobile device, a search query, as one step, of a plurality of steps, of a current electronic workflow followed in association with an incident; compares the search query with stored search queries received from other user mobile devices as a respective step of previously implemented respective electronic workflows, different from the current electronic workflow, as stored at one or more memories; in response to matching the search query with a stored search query of a previously implemented electronic workflow, compares remaining steps of the current electronic workflow with respective executed steps of the previously implemented electronic workflow; and, in response to determining an overlap between the remaining steps and the respective executed steps, causes one or more overlapping steps to be skipped in the current electronic workflow.

### BACKGROUND OF THE INVENTION

Implementation of electronic workflows at mobile devices may assist users with correctly implementing and electronically documenting tasks for an incident. For example, police officers, and the like, operating checkpoints in a search for a suspect, and the like, may be required to perform certain steps. Similarly, police officers, and the like, stopping speeding vehicles may be required to perform other certain steps. Such steps may be electronically provided on a mobile device operated by a police officer as an electronic workflow. In other examples, electronic workflows may be implemented in warehouses, hotels, restaurants and/or in other suitable workplaces, and the like, to provide electronic workflow steps to workers in performing tasks for related incidents. Efficient implementation of electronic workflows at the mobile devices may hence be imperative for efficient use of processing and bandwidth resources in completing tasks and/or in dealing with incidents, and for ensuring consistent electronic recordation and storage of performed steps in an electronic workflow.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system for modifying electronic workflows, in accordance with some examples.

FIG. 2 is a device diagram showing a device structure of computing device for modifying electronic workflows, in accordance with some examples.

FIG. 3 is a flowchart of a method for modifying electronic workflows, in accordance with some examples.

FIG. 4 depicts aspects of an example of a method for modifying electronic workflows implemented in the system of FIG. 1.

FIG. 5 depicts further aspects of the example of the method for modifying electronic workflows implemented in the system of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Implementation of electronic workflows at mobile devices may assist users with correctly implementing and electronically documenting tasks for an incident. For example, police officers, and the like, operating checkpoints in a search for a suspect, and the like, may be required to perform certain steps. Similarly, police officers, and the like, stopping speeding vehicles may be required to perform other certain steps. Such steps may be electronically provided on a mobile device operated by a police officer as an electronic workflow. In other examples, electronic workflows may be implemented in warehouses, hotels, restaurants and/or in other suitable workplaces, and the like, to provide electronic workflow steps to workers in performing tasks for related incidents. Efficient implementation of electronic workflows at the mobile devices may hence be imperative for efficient use of processing and bandwidth resources in completing tasks and/or in dealing with incidents, and for ensuring consistent electronic recordation and storage of performed steps in an electronic workflow.

Hence, provided herein is a device, system and method for modifying electronic workflows, for example to eliminate and/or reduce redundant and/or overlapping steps between electronic workflows to better utilize processing, bandwidth, and electronic storage resources at the devices of the system. In particular, a computing device, such as a server and/or a cloud device operated by an entity such as a public-safety entity or a business entity, and the like, may receive an electronic search query from a user mobile device as one step, of a plurality of steps, of a current electronic workflow being implemented via the user mobile device. The current electronic workflow may be implemented in association with an incident, which may be a public-safety incident and/or workplace incident, and the like. In a particular example with regards to public-safety, such an incident may include a speeding incident in which a police officer pulls over a vehicle for speeding; in this example, a user mobile device operated by the police officer implements a speeding electronic workflow, which may include an electronic search query for a license plate number of the vehicle (e.g., via the police officer operating the user mobile device), amongst other steps in an electronic work-flow.

The computing device may compare the electronic search query with stored electronic search queries received from other user mobile devices that previously implemented respective electronic workflows different from the current electronic workflow. For example the computing device may compare the license plate number of the search query with other search queries of previously implemented workflows to determine whether the other search queries included the same license plate number. A match, and the like, may occur when the license plate number matches a license plate number of a search query of a previously implemented checkpoint electronic workflow. For example, the same car may have been pulled over by another police officer at a checkpoint in a search for a suspect, and the like (e.g., in a checkpoint incident), and the license plate number may have been checked in a search query conducted in association with a checkpoint electronic workflow.

When a match occurs, the computing device compares remaining steps of the current electronic workflow with the previously executed steps of the previously implemented different electronic workflow to determine whether any of the steps overlap. For example, a remaining step in the current speeding electronic workflow may be a trunk check, and a previously executed step of the previously implemented checkpoint electronic workflow may have included a trunk check.

When such an overlap occurs, the computing device may transmit a notification to the user mobile device to skip the overlapping step(s), which may include, but is not limited to, a modified electronic workflow (e.g., a modified speeding electronic workflow) that omits the overlapping step(s) and/or indicates (e.g. and which may be visually via a display screen) that that the overlapping steps were already completed (e.g. and which may include additional context of the prior completion displayed), and/or the computing device may store the modified electronic workflow at a memory for retrieval by the user mobile device.

Regardless, the computing device causes the user mobile device to skip the overlapping steps, such as the trunk check, in implementing the current electronic workflow, which saves the user mobile device from processing data in the trunk check, as well as saves processing resources at the computing device that may have processed such data when transmitted thereto by the user mobile device; utilized bandwidth between the user mobile device and the computing device may also be reduced, and electronic storage may be reduced by refraining from storing indications, media, text, or other content regarding the overlapping step. Such skipping of the overlapping steps may also better utilize human resources at the incident (e.g.. the police officer at the speeding incident is saved from doing a trunk check and/or incurring injuries during the additional work).

Such skipping of the overlapping steps and/or modification of a current electronic workflow, may be further based on time, distance and the like between incidents (e.g., the speeding incident and the checkpoint incident). For example, the trunk check may be omitted from the speeding electronic workflow when the speeding incident and the checkpoint incident are within a given time period of each other and/or when the incidents are within a given distance of each other. However, skipping or retaining overlapping steps may be based on predetermined rules, amongst other possibilities.

An aspect of the present specification provides a method comprising: receiving, at a computing device, from a user mobile device, a search query, as one step, of a plurality of steps, of a current electronic workflow followed in association with an incident; comparing, via the computing device, the search query with stored search queries received from other user mobile devices as a respective step of previously implemented respective electronic workflows, different from the current electronic workflow, as stored at one or more memories; in response to matching the search query with a stored search query of a previously implemented electronic workflow, comparing, via the computing device, remaining steps of the current electronic workflow with respective executed steps of the previously implemented electronic workflow; and, in response to determining an overlap between the remaining steps and the respective executed steps, causing, via the computing device, one or more overlapping steps to be skipped in the current electronic workflow.

Another aspect of the present specification provides a device comprising: a communication unit configured to communicate with user mobile devices; a controller communicate coupled to the communication unit and one or more memories, controller configured to: receive, via the communication unit, from a user mobile device, a search query, as one step, of a plurality of steps, of a current electronic workflow followed in association with an incident; compare the search query with stored search queries received from other user mobile devices as a respective step of previously implemented respective electronic workflows, different from the current electronic workflow, as stored at the one or more memories; in response to matching the search query with a stored search query of a previously implemented electronic workflow, compare remaining steps of the current electronic workflow with respective executed steps of the previously implemented electronic workflow; and, in response to determining an overlap between the remaining steps and the respective executed steps, cause one or more overlapping steps to be skipped in the current electronic workflow.

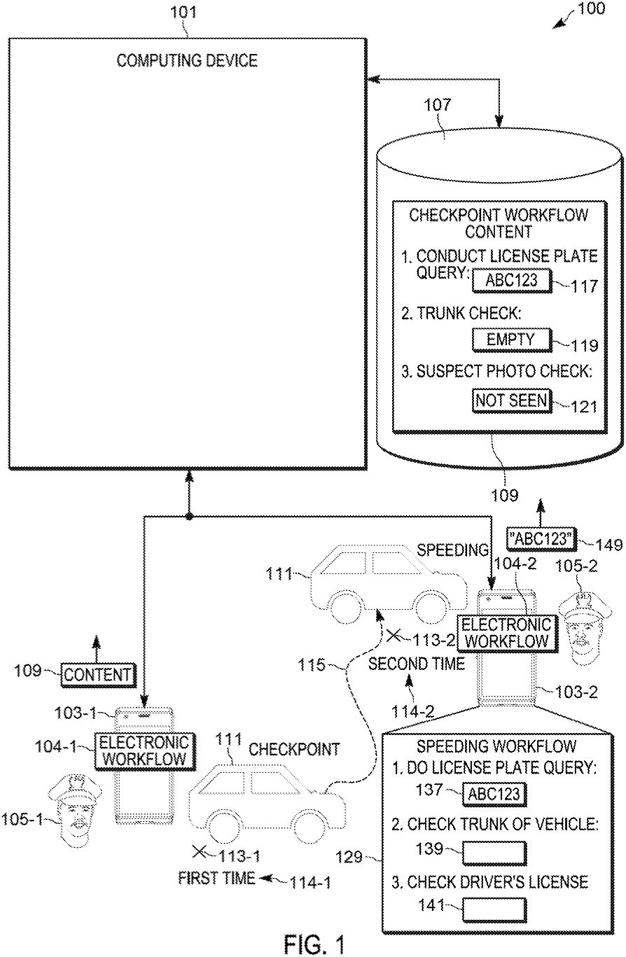

Attention is directed to FIG. 1, which depicts an example system 100 for modifying electronic workflows. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

While present examples are described with respect to a computing device and user mobile devices associated with a public-safety entity (e.g., such as a police department, and the like), computing devices and user mobile devices associated with other types of entities may leverage a same or similar technique as described herein. For example, computing devices and user mobile devices associated with a warehousing entity, a service industry entity (e.g., a hotel entity, a restaurant entity and/or any suitable entity that may implement electronic workflows in association with incidents) may implement a same or similar technique as described herein.

Similarly, the term “incident” is used throughout the present specification in association with public-safety incidents, such as police checkpoints, speeding, and the like. However, the term “incident” may similarly refer to other types of incidents in any suitable workplace environment, and the like, which may be managed, and the like, using electronic workflows. For example, in a warehouse, an incident may include a worker being tasked with checking goods to verify an inventory record (e.g., an inventor incident), and the like, and/or a worker being tasked with picking up goods in the warehouse to complete an order (e.g., a pick-up incident), and the like. Similarly, in a hotel, an incident may include a worker being tasked with repairing a broken item in a room (e.g., such as a plumbing of a bathtub, and the like) (e.g., a repair incident), and the like, and/or a worker being tasked with cleaning a room (e.g., a cleaning incident). As such, the term “incident” may be used interchangeably herein with the term “task”, and the like.

The system 100 comprises a computing device 101 in communication with user mobile devices 103-1, 103-2. As depicted, the user mobile devices 103-1, 103-2 are implementing respective electronic workflows 104-1, 104-2. Furthermore, the user mobile devices 103-1, 103-2 are respectively operated by users 105-1, 105-2 (e.g., as depicted police officers). As depicted, the computing device 101 is in further communication with one or more memories, such as a memory 107, which may be in the form of a non-transitory, non-volatile database, and the like, storing content 109 of a previously implemented electronic workflow 104 received via electronic transmission from other mobile devices, as described in more detail below.

The user mobile devices 103-1, 103-2 are interchangeably referred to hereafter, collectively, as the user mobile devices 103 and/or the mobile devices 103 and, generically, as a user mobile device 103 and/or a mobile device 103. This numbering convention will be used throughout the present specification. For example, the electronic workflows 104-1, 104-1 are interchangeably referred to hereafter, collectively, as the electronic workflows 104 and, generically, as an electronic workflow 104. Similarly, the users 105-1, 105-2 are interchangeably referred to hereafter, collectively, as the users 105 and, generically, as a user 105.

As depicted, the users 105 are depicted as police officers engaged in public-safety incidents (e.g., a “CHECKPOINT” incident and a “SPEEDING” incident) and/or tasks, and are operating the mobile devices 103 to implement different public-safety electronic workflows 104 (e.g., a checkpoint electronic workflow and a speeding electronic workflow) to assist in the incidents. However, the users 105 may be any suitable users operating any suitable number of mobile devices 103 to implement any suitable number of electronic workflows 104. For example, a plurality of users 105 may be engaged in a search for a suspect and hence may be at a plurality of checkpoints, operating respective mobile devices 103 to implement respective checkpoint electronic workflows 104.

While the mobile devices 103 are depicted as, for example, cell-phone mobile devices, and the like, the mobile devices 103 may comprise any suitable mobile device including, but not limited to, radios, vehicular mobile devices, laptop computers, warehousing mobile devices (e.g., adapted for warehouse barcode scanning and the like), hotel mobile devices (e.g., mobile devices which includes one or more restaurant-related applications, for example for taking orders in a restaurant, and the like), hotel mobile devices (e.g., mobile devices which includes one or more hotel-related applications, for example for looking up service orders and/or maintenance orders for rooms in a hotel, and the like) and the like.

Similarly, while the content 109 of only one previously implemented electronic workflow 104 is depicted, the memory 107 (and/or one or more memories) may store content of any suitable number of previously implemented electronic workflows 104; for example, respective content of previously implemented electronic workflows 104 for a plurality of checkpoints may be stored.

As understood herein, an electronic workflow 104 may comprise an application, and/or applications, and the like, implemented by a mobile device 103 to instruct a respective user 105 to implement one or more steps to assist with an incident and/or perform a task, and the like. Hence, while the electronic workflows 104 are depicted as being on top of a respective mobile device 103, it is understood that the electronic workflows 104 are being implemented by respective controllers and/or processors of the mobile devices 103.

In general, an electronic workflow 104 may include an application that, when processed by a mobile device 103, controls the mobile device 103 to provide instructions and/or notifications at a mobile device 103 (e.g., at a display screen thereof) to perform a particular step (e.g., “Conduct License Plate Query”). Such instructions and/or notifications may include fields, and the like for collecting data and/or content in the steps (e.g., via a user 105 operating a respective input device of a mobile device 103) and/or electronic soft-buttons, and the like, for initiating search queries, storing content, and the like, for example, to transmit the search query and/or to cause the content received at a field to be transmitted to the computing device 101 and stored (e.g., at the memory 107). Furthermore, certain data and/or content may be received via an associated application (e.g., such as a license plate check application, a driver’s license check application, a warehouse barcode scanning application, and the like) being implemented at a mobile device 103. Alternatively, such search queries and/or storing of content may be initiated by a user 105 operating a respective input device of a mobile device 103 to enter data and/or content into a field of an electronic workflow 104, and/or an associated application, and a hard button of an input device may be used to transmit a search query and/or to cause the content received at the field to be transmitted and stored (e.g., at the memory 107).

In particular, as will be explained in more detail below, the computing device 101 may be configured to assist the user mobile devices 103 with implementing the electronic workflows 104, for example to cause steps of a currently implemented electronic workflow 104, which overlap with previously executed steps of a previously implemented electronic workflow 104, to be omitted (e.g., skipped and/or otherwise visually removed, visually stricken and the like, from a display screen of a user mobile device 103) from the currently implemented electronic workflow 104.

For example, as depicted, a vehicle 111 is first stopped by the user 105-1, for example in a checkpoint stop and/or a checkpoint incident at a first location 113-1 to check the vehicle 111 for a suspect and the like. The user 105-1 may operate the mobile device 103-1 to implement the electronic workflow 104-1, which may comprise a checkpoint electronic workflow, to assist with the checkpoint incident.

The vehicle 111 then travels to a second location 113-2 (e.g., such travel indicated by a dashed line 115) where the vehicle 111 is pulled over by the user 105-2 for speeding, for example in a speeding incident. The user 105-2 may operate the mobile device 103-2 to implement the electronic workflow 104-2, which may comprise a speeding electronic workflow, to assist with the checkpoint incident.

Hence, it is understood that FIG. 1 depicts the vehicle 111 at the location 113-1 at a first time 114-1, and FIG. 1 further depicts the vehicle 111 at the location 113-2 at a second time 114-2 after the first time 114-1 and/or later than the first time 114-1. Put another way, at the first time 114-1, the vehicle 111 is stopped by the user 105-1 in association with a first incident (e.g., the checkpoint incident) at the location 113-1; and, at the second time 114-2, later than the first time 114-1, the vehicle 111 is stopped by the user 105-2 in association with a second incident (e.g., the speeding incident) at the location 113-2. The locations 113-1, 113-2 are interchangeably referred to hereafter as the locations 113 and/or a location 113, and the times 114-1, 114-2 are interchangeably referred to hereafter as the times 114 and/or a time 114. Furthermore, the first incident and the second incident are different from one another.

In the present example, the electronic workflow 104-1 is understood to comprise a previously implemented checkpoint electronic workflow; hence, the electronic workflow 104-1 will be interchangeably referred to, hereafter, as the checkpoint electronic workflow 104-1 and/or the previously implemented electronic workflow 104-1. Similarly, presuming the speeding incident is presently occurring, the electronic workflow 104-2 will be interchangeably referred to, hereafter, as the speeding electronic workflow 104-2 and/or the current electronic workflow 104-2.

At the location 113-1 and the first time 114-1, the user 105-1 operates the mobile device 103-1 to implement the checkpoint electronic workflow 104-1. While not depicted, steps of the checkpoint electronic workflow 104-1 may be provided in a window, and the like, at a display screen of the mobile device 103-1 (e.g., a similar window is described below in association with the mobile device 103-2 implementing the speeding electronic workflow 104-2).

The mobile device 103-1 generates the content 109, which is electronically transmitted to the computing device 101 by the mobile device 103-1 and stored at the memory 107. In particular, with reference to the content 109 stored at the memory 107, the checkpoint electronic workflow 104-1 comprises a plurality of steps, which includes, but is not limited to, a license plate search query, a trunk check and a suspect photo check. As depicted, the content 109 includes the steps of the checkpoint electronic workflow 104-1 depicted as text indicating the steps, and numbered as “1”, “2” and “3”, which may indicate an order in which the steps were performed, though the steps may be performed in any suitable order.

For example, as depicted, a first step (e.g., “1”) in the checkpoint electronic workflow 104-1 comprises “Conduct License Plate Query” a second step (e.g., “2”) in the checkpoint electronic workflow 104-1 comprises a “Trunk Check”, and a third step (e.g., “3”) in the checkpoint electronic workflow 104-1 comprises a “Suspect Photo Check”. However, the checkpoint electronic workflow 104-1 may comprise any suitable number of steps, in any suitable order.

The first step of the checkpoint electronic workflow 104-1 may include the mobile device 103-1 electronically providing instructions (e.g., at a display screen thereof) to notify the user 105-1 to operate the mobile device 103-1 to transmit a search query to a license plate database (not depicted), and the like, to conduct a search for the license plate number of the vehicle 111. For example, as depicted, the content 109 includes content 117 of such a search query (e.g., license plate number “ABC123”, which is understood to be the license plate number of the vehicle 111). Hence, the content 117 may alternatively be referred to as a stored search query. In other examples, the electronic workflow 104-1 may be partially, or fully, automated using a combination of one or more of automatic license plate readers, video analytics, and/or drones available at and/or near (e.g. within communication range) of the user mobile device 103-1, among other possibilities.

The second step of the checkpoint electronic workflow 104-1 may include the mobile device 103-1 providing instructions (e.g., at a display screen thereof) to notify the user 105-1 to check the trunk of the vehicle 111 for a suspect (e.g., who may be hiding in the trunk) and thereafter operate the mobile device 103-1 to enter and/or select data indicative of the results of the trunk check. For example, as depicted, the content 109 includes content 119 (e.g., in the form of text, and the like) indicating that the trunk was “Empty”. In this example, the content 119 may be received at the mobile device 103-1 as text and/or may be selected from a pulldown menu, and the like.

The third step of the checkpoint electronic workflow 104-1 may include the mobile device 103-1 providing instructions (e.g., at a display screen thereof) to notify the user 105-1 to show occupants (e.g., a driver and passengers if any) of the vehicle 111 a photo of the suspect, and thereafter operate the mobile device 103-1 to enter and/or select data indicative of the results of the suspect photo check. For example, as depicted, the content 109 includes content 121 (e.g., in the form of text, and the like) indicating that the suspect was “Not Seen”.

When an electronic workflow 104 includes implementing a search query, such as the license plate search query, the search query may be electronically transmitted to the computing device 101, which may act as an intermediary between the mobile devices 103 and other databases (e.g., such a license plate database) to perform a search based on the search query; in these examples, the computing device 101 may collect the content 117 of the search query in such mediation of communications, and store the content 117 at the memory 107.

Alternatively, such a search query may occur via the mobile devices 103 electronically communicating with such other databases, without using the computing device 101 as an intermediary between the mobile devices 103 and the other databases; in these examples, the mobile devices 103 may transmit the content 117 of the search query to the computing device 101 for storage.

It is further understood that the mobile devices 103, may be preconfigured with steps of respective electronic workflows 104 to be implemented and such steps may be transmitted to the computing device 101 when an electronic workflow 104 is processed and/or implemented at a mobile device 103. Alternatively, the computing device 101 may have access to a database, and the like, storing various electronic workflows 104 and a mobile device 103 may transmit an indication of an electronic workflow 104 being implemented to the computing device 101 (e.g., an identification number, and the like) such that the computing device 101 may retrieve steps of the electronic workflow 104 being implemented. Regardless, it is understood that the computing device 101 generally has access to steps of an electronic workflow 104 being implemented at a mobile device 103, and receives content associated with the steps, including, but not limited to content of search queries, which is stored at the memory 107 and/or any suitable memory and/or memories in any suitable format.

For example, while the content 109 includes both the steps of the electronic workflow 104-1 and respective content 117, 119, 121 collected in association with implementing the steps of the electronic workflow 104-1, in other examples, the content 109 may omit the steps and include the content 117, 119, 121 stored in association with an indicator (e.g., an alphanumeric identifier and/or a database location, and the like), of the electronic workflow 104-1 implemented when the content 117, 119, 121 was collected. Furthermore, regardless of format of the content 109, the content 117 may be specifically identified as being content of a search query.

As also depicted in FIG. 1, at the location 113-2 and the second time 114-2 (later than the first time 114-1 and which may be a current time), the user 105-2 stops the vehicle 111 for speeding and operates the mobile device 103-2 to implement the speeding electronic workflow 104-2. For example, as depicted, to implement the speeding electronic workflow 104-2, the mobile device 103-2 provides a window 129, which may be rendered at a display screen of the mobile device 103-2. In particular, the window 129 shows instructions for implementing the steps of the speeding electronic workflow 104-2. The window 129 is depicted adjacent the mobile device 103-2 such that details of the instructions for implementing the steps of the speeding electronic workflow 104-2 may be seen in better detail.

For example, as depicted, a first step (e.g., “1”) in the speeding electronic workflow 104-2 comprises “Do License Plate Query”, a second step (e.g., “2”) in the speeding electronic workflow 104-2 comprises “Check Trunk Of Vehicle”, and a third step (e.g., “3”) in the speeding electronic workflow 104-2 comprises “Check Driver’s License”. However, the speeding electronic workflow 104-2 may comprise any suitable number of steps, in any suitable order.

Furthermore, the speeding electronic workflow 104-2 includes a field 137 for receiving content (e.g., a license plate number) that may be used in a search query for the license plate query. Similarly, the speeding electronic workflow 104-2 includes a field 139 for receiving content that indicates the result of the check of the trunk. The field 139 may include, but is not limited to, a field for receiving alphanumeric text and/or a pull down menu to select from options for the trunk being empty, not empty, containing firearms, hiding a person, and the like. Similarly, the speeding electronic workflow 104-2 includes a field 141 for receiving content that that may be used in a check of the driver’s license (e.g., for receiving a driver’s license number, which may be used in a search query for a driver’s license).

As depicted, the field 137 is populated, but the fields 139, 141 are not yet populated. For example, as depicted, the user 105-2 has currently operated an input device, such as a keyboard, and the like, at the mobile device 103-2 to enter the license plate number (e.g., “ABC123”) of the vehicle 111 in the field 137. As such, the first step of the speeding electronic workflow 104-2 has been implemented, but the second step and the third step have not yet been implemented; as such the second step and the third step may be referred to as remaining steps of the speeding electronic workflow 104-2. In particular, hereafter, the term remaining steps of an electronic workflow 104 may be understood to include steps of an electronic workflow 104 that are not yet implemented and/or remain to be implemented.

As will be explained in more detail below, once the license plate number is received at the field 137, the mobile device 103-2 may transmit a search query 149 to the computing device 101, that includes the license plate number. As will be explained in more detail below, the computing device 101 receives the search query 149 and compares content of the search query 149 against the content 109 of the checkpoint electronic workflow 104-1. When a match is electronically determined (e.g., the license plate number of the search query 149 may match the license plate number of the content 117), the computing device 101 may modify the speeding electronic workflow 104-2 to omit one or more steps that overlap with the steps of the previously implemented checkpoint electronic workflow 104-1, such as a trunk check. For example, the computing device 101 may electronically determine that the step “Check Trunk Of Vehicle”, of the current electronic speeding workflow 104-2, overlaps with the “Trunk Check” step of the previously implemented checkpoint electronic workflow 104-1. As such, the computing device 101 may cause the step “Check Trunk Of Vehicle”, of the current electronic speeding workflow 104-2 to be omitted at the mobile device 103-2.

For example, as explained in more detail below, the computing device 101 may transmit an indication to the mobile device 103-2, which causes the mobile device 103-2 to omit one or more overlapping steps of the speeding electronic workflow 104-2 that overlap with steps of the previously implemented checkpoint electronic workflow 104-1. Such an indication may include a notification to one or more of: skip the one or more overlapping steps; and notify that the one or more overlapping steps were completed in the previously implemented check-point electronic workflow 104-1, thereby causing the speeding electronic workflow 104-2 to be modified at the mobile device 103-2 (e.g., removing the trunk check), making the speeding electronic workflow 104-2 more efficient and/or quicker to implement.

Alternatively, the computing device 101 may store a modified speeding electronic workflow, which omits the one or more overlapping steps, at one or more memories, such as the memory 107, and the modified speeding electronic workflow may be retrieved by the mobile device 103-2. For example, after the search query 149 is transmitted, the mobile device 103-2 may query the memory 107, and the like, for a modified electronic workflow and retrieve such a modified electronic work-flow to implement in place of the speeding electronic workflow 104-2.

However, the computing device 101 may cause the mobile device 103-2 to skip the one or more overlapping steps in any suitable manner, as described in more detail below.

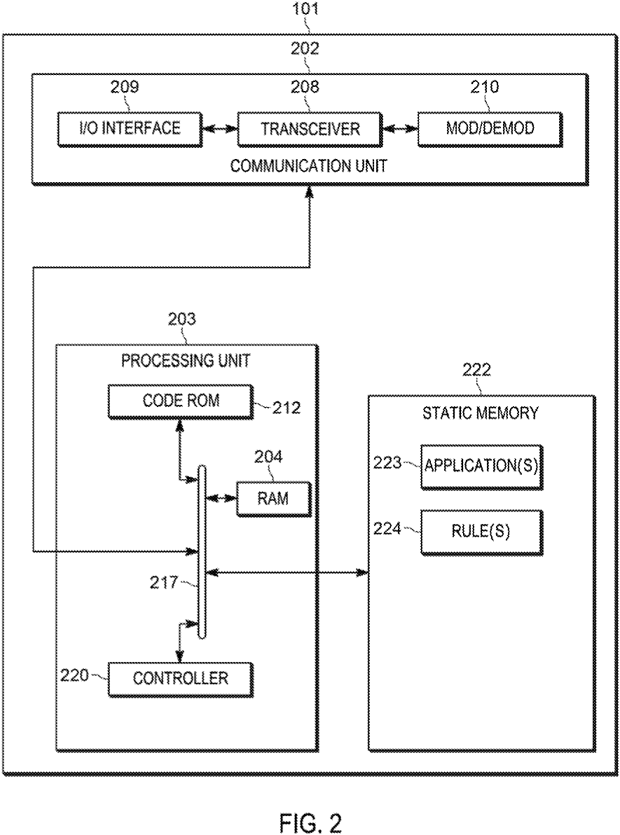

Attention is next directed to FIG. 2, which depicts a schematic block diagram of an example of the computing device 101. In general, the computing device 101 may comprise one or more servers and/or one or more cloud computing devices, and the like, configured to communicate with the user mobile devices 103 and/or any other suitable component of the system 100, such as the memory 107. However, the computing device 101 may comprise a computing device such as a personal computer and/or a laptop computer, and the like. Indeed, in some examples, functionality of the computing device 101 may be combined with one or more of the user mobile devices 103.

As depicted, the computing device 101 comprises: a communication unit 202, a processing unit 203, a Random-Access Memory (RAM) 204, one or more wireless transceivers 208, one or more wired and/or wireless input/output (I/O) interfaces 209, a combined modulator/demodulator 210, a code Read Only Memory (ROM) 212, a common data and address bus 217, a controller 220, and a static memory 222 storing at least one application 223. Hereafter, the at least one application 223 will be interchangeably referred to as the application 223.

While not depicted, the computing device 101 may include one or more of an input device and a display screen and the like, a microphone (e.g., to receive voice commands) such that a user (e.g., an administrator of the system 100), may interact with the computing device 101. In some examples, the computing device 101 may include a clock, and the like (including, but not limited to, a clock of the controller 220 and/or the processing unit 203), which may be used to determine a time at which an electronic workflow is being implemented at a mobile device 103 (e.g., via a time of receipt of electronic workflow search queries and/or electronic workflow content at the computing device 101).

As shown in FIG. 2, the computing device 101 includes the communication unit 202 communicatively coupled to the common data and address bus 217 of the processing unit 203.

The processing unit 203 may include the code Read Only Memory (ROM) 212 coupled to the common data and address bus 217 for storing data for initializing system components. The processing unit 203 may further include the controller 220 coupled, by the common data and address bus 217, to the Random-Access Memory 204 and the static memory 222.

The communication unit 202 may include one or more wired and/or wireless input/output (I/O) interfaces 209 that are configurable to communicate with the user mobile devices 103 and/or any other suitable component of the system 100. For example, the communication unit 202 may include one or more transceivers 208 and/or wireless transceivers for communicating with the user mobile devices 103 and/or any other suitable component of the system 100. Hence, the one or more transceivers 208 may be adapted for communication with one or more communication networks used to communicate with the user mobile devices 103 and/or any other suitable component of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3^{rd} Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication unit 202 may optionally include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The controller 220 may include ports (e.g., hardware ports) for coupling to other hardware components.

The controller 220 may include one or more logic circuits, one or more processors, one or more microprocessors, and/or the controller 220 may include one or more ASIC (application-specific integrated circuits) and one or more FPGA (field-progranunable gate arrays), and/or another electronic device. In some examples, the controller 220 and/or the computing device 101 is not a generic controller and/or a generic device, but a device specifically configured to implement functionality for modifying electronic workflows. For example, in some examples, the computing device 101 and/or the controller 220 specifically comprises a computer executable engine configured to implement functionality for modifying electronic workflows.

The static memory 222 is a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functional teachings of the computing device 101 as described herein are maintained, persistently, at the memory 222 and used by the controller 220, which makes appropriate utilization of volatile storage during the execution of such programming instructions.

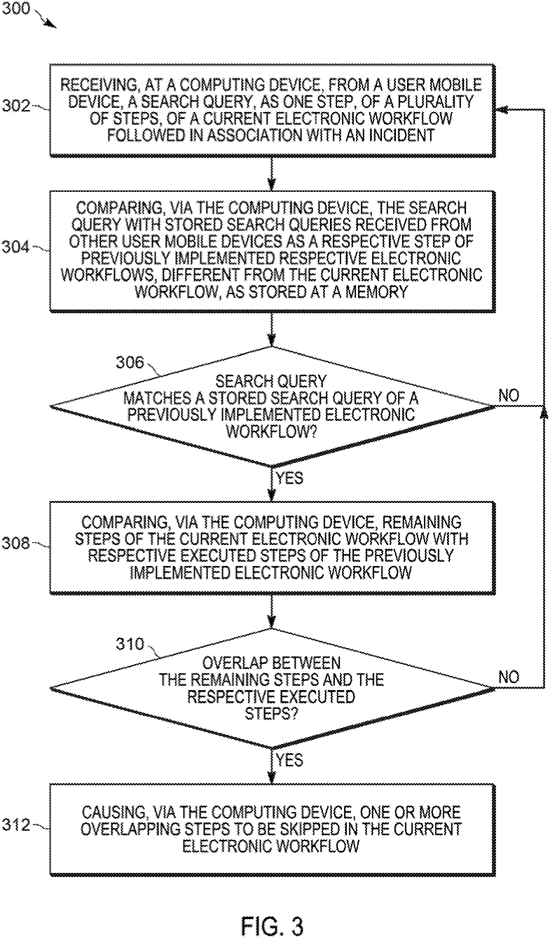

In particular, the memory 222 stores instructions corresponding to the at least one application 223 that, when executed by the controller 220, enables the controller 220 to implement functionality described herein including, but not limited to, the blocks of the method set forth in FIG. 3.

In illustrated examples, when the controller 220 executes the one or more applications 223, the controller 220 is enabled to: receive, from a user mobile device, a search query, as one step, of a plurality of steps, of a current electronic workflow followed in association with an incident; compare, the search query with stored search queries received from other user mobile devices as a respective step of previously implemented respective electronic workflows, different from the current electronic workflow, as stored at one or more memories; in response to matching the search query with a stored search query of a previously implemented electronic workflow, compare remaining steps of the current electronic workflow with respective executed steps of the previously implemented electronic workflow; and, in response to determining an overlap between the remaining steps and the respective executed steps, cause one or more overlapping steps to be skipped in the current electronic workflow.

As depicted, the memory 222 may further store one or more predetermined rules 224 that includes criteria for one or more of refraining from skipping (e.g. and/or refraining from visually removing and/or visually striking, at a display screen) a given overlapping step (e.g., retaining an overlapping step), adding a step to an electronic workflow, and the like, for example when the given overlapping step meets respective criteria, as described in more detail below. While the one or more predetermined rules 224 are depicted as being separate from the application 223. in other examples, the one or more predetermined rules 224 may be incorporated into the application 223.

The application 223 may include numerical algorithms configured to implement the functionality as described above and/or determine whether search queries match and/or determine whether two or more electronic workflows have overlapping steps, and/or any other suitable functionality of the computing device 101.

Alternatively, and/or in addition to numerical algorithms, the application 223 may include machine learning models and/or algorithms, and the like, which have been trained to implement the functionality as described above and/or determine whether search queries match and/or determine whether two or more electronic workflows have overlapping steps, and/or any other suitable functionality of the computing device 101. The one or more machine learning models and/or algorithms of the application 223 may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like, in some public safety environments. Any suitable machine learning algorithm and/or deep learning algorithm and/or neural network is within the scope of present examples.

While details of the mobile devices 103 are not depicted, the mobile devices 103 may have components similar to the computing device 101 adapted, however, for the functionality thereof. For example, the mobile device 103 may include respective display screens for providing electronic workflows, input devices, speakers, microphones, location determining devices (e.g., GPS devices), clocks (including, but not limited to, a clock of a respective controller and/or processor) and the like. In particular, in some examples, the mobile devices 103 may be configured to determine a respective location and/or a time at which an electronic workflow is being implemented.

Attention is now directed to FIG. 3, which depicts a flowchart representative of a method 300 for modifying electronic workflows. The operations of the method 300 of FIG. 3 correspond to machine readable instructions that are executed by the computing device 101, and specifically the controller 220 of the computing device 101. In the illustrated example, the instructions represented by the blocks of FIG. 3 are stored at the memory 222 for example, as the application 223. The method 300 of FIG. 3 is one way that the controller 220 and/or the computing device 101 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

In the following description of the method 300, it is understood that the method 300 is being implemented at, and/or around, the second time 114-2, with the speeding electronic workflow 104-2 being currently implemented, and the checkpoint electronic workflow 104-1 was previously implemented at, and/or around, the first time 114-1. As such, as previously described herein, the electronic workflow 104-2 is interchangeably referred to hereafter as the current electronic workflow 104-2; similarly, the electronic workflow 104-1 is interchangeably referred to hereafter as the previously implemented electronic workflow 104-1.

At a block 302, the controller 220 and/or the computing device 101 receives, from a user mobile device 103, a search query 149, as one step, of a plurality of steps, of a current electronic workflow 104-2 followed in association with an incident, as described above.

At a block 304, the controller 220 and/or the computing device 101 compares, the search query 149 with stored search queries received from other user mobile devices 103 as a respective step of previously implemented respective electronic workflows 104, different from the current electronic workflow 104-2, as stored at one or more memories, such as the memory 107. Hence, for example, the controller 220 and/or the computing device 101 may compare content of the search query 149 with the content 117 of a stored search query of the previously implemented electronic workflow 104-1, as well as stored search queries of any other previously implemented electronic workflows 104.

At a block 306, the controller 220 and/or the computing device 101 determines whether the search query 149 matches a stored search query of a previously implemented electronic workflow 104-1. Put another way, the controller 220 and/or the computing device 101 may determine whether content of the search query 149 matches respective content 117 of the stored search queries. For example, as depicted, a match may occur when the license plate number of the search query 149 matches the content 117 of a stored search query.

However, while present examples are described with respect to comparing license plate numbers, and hence an exact match between content of search queries may occur, in other examples, search queries may be determined to match when their respective content is not an exact match.

For example, rather than a license plate, electronic workflows 104 may include a search query for a make, model number and color of the vehicle 111, and/or a search query for a given name of a driver of the vehicle 111 (e.g., in place of a license plate check and/or in addition to a license plate check). In such examples, different spellings of names of makes, models, numbers and/or drivers, and the like, may be used in the various search queries, among other possibilities. For example in warehousing electronic workflows, a search query may include a textual description of a particular type of item stored at a warehouse and/or an employee name, and the like. Similarly, for example in hotel electronic workflows, a search query include a textual description of a particular room service item and/or a guest name and/or an employee name, and the like. Hence, for example, the controller 220 and/or the computing device 101 may determine that search queries match using one or more threshold values and/or confidence threshold values (e.g., as configured at the application 223). For example, when a match between two search queries is determined within a 90% confidence level, the controller 220 and/or the computing device 101 may determine that two search queries match. However, a matching threshold confidence level may be selected to be any suitable value, for example 70%, 80%, or 90%.

In response to determining that the search query 149 does not match a stored search query of a previously implemented electronic workflow 104 (e.g., a “NO” decision at the block 306), the controller 220 and/or the computing device 101 returns to the block 302 to wait for further search queries.

However, in response to matching the search query 149 with a stored search query (e.g., as represented by the content 117) of the previously implemented electronic workflow 104-1 (e.g., a “YES” decision at the block 306), at a block 308, the controller 220 and/or the computing device 101 compares remaining steps of the current electronic workflow 104-2 with respective executed steps of the previously implemented electronic workflow 104-1, to determine, for example, whether any remaining steps of the current electronic workflow 104-2 overlap with respective executed steps of the previously implemented electronic workflow 104-1.

At a block 310, the controller 220 and/or the computing device 101 determines whether there is an overlap between the remaining steps and the respective executed steps.

For example, the controller 220 and/or the computing device 101 may determine that an overlap between the remaining steps and the respective executed steps occurs by determining that the one or more overlapping steps are duplicates of one or more of the respective executed steps. Similarly, the controller 220 and/or the computing device 101 may determine that an overlap between the remaining steps and the respective executed steps occurs by determining that the one or more overlapping steps are an equivalent of one or more of the respective executed steps.

For example, as described previously, the previously implemented electronic workflow 104-1 includes a previously executed step “Trunk Check” and the current electronic workflow 104-2 includes a remaining step “Check Trunk Of Vehicle”. While such steps are indicated differently, for example by different text, they are equivalent to each other as they lead to a same task and/or action being performed by the user 105-2 (e.g., a check of the trunk of the vehicle 111) and/or by one or more other electronic devices, such as an automated drone with video camera and analytics, and the like. Hence, the remaining step “Check Trunk Of Vehicle” of the current electronic workflow 104-2 may be determined to overlap with the previously executed step “Trunk Check” of the previously implemented electronic workflow 104-1.

In contrast, as no step of the previously implemented electronic workflow 104-1 includes a previously executed step similar to, and/or the same as “Check Driver’s License” step of the current electronic workflow 104-2, the “Check Driver’s License” step of the current electronic workflow 104-2 is determined not to overlap with previously executed steps of the previously implemented electronic workflow 104-1.

Hence, by determining whether steps of electronic workflows 104 overlap, and/or by determining whether the steps are duplicates and/or the same and/or similar and/or are equivalent to each other, the controller 220 and/or the computing device 101 may determine whether a remaining step of the current electronic workflow 104-2 is redundant with a previously executed step of the previously implemented workflow 104-1 and hence may be skipped. In the example above, the “Check Trunk Of Vehicle” may be redundant, while the “Check Driver’s License” step may not be redundant.

Such a determination of overlapping steps may occur by comparing text, and the like, of the steps of the electronic workflows 104 to determine a match, which may be exact (e.g., such that overlapping steps are duplicates of each other), and/or may include similar text (e.g., “Trunk Check” and “Check Trunk Of Vehicle”) and/or a determination of overlapping steps may be based on confidence levels and threshold confidence levels, as described above with respect to comparing search queries. For example, a comparison of the steps “Trunk Check” and “Check Trunk Of Vehicle” may be assigned a matching confidence level of 95%, and a threshold confidence level may be 70%, 80%, 90% and/or any other suitable value; when the confidence level of 95% is greater than the threshold confidence level, the controller 220 and/or the computing device 101 may determine that the steps overlap.

However, overlapping steps may be determined in any suitable manner. For example, the computing device 101 (e.g., via the application 223 and/or the rules 224) may be preconfigured with electronic indications of overlapping steps of pairs of electronic workflows 104. Hence, for example, when the electronic workflows 104-1, 104-2 are being compared to determine overlapping steps, the computing device 101 may already be preconfigured to determine that respective second steps thereof overlap (e.g., the “Trunk Check” and “Check Trunk Of Vehicle” steps).

However, in some examples, the controller 220 and/or the computing device 101 may further determine to retain or omit overlapping steps from the current electronic workflow 104-2 based, for example, on criteria of the rules 224, and the like. For example, the controller 220 and/or the computing device 101 may further determine to retain or omit overlapping steps from the current electronic workflow 104-2 based on one or more of: a time between an incident associated with the current electronic workflow 104-2 (e.g., the speeding incident) and a previous incident associated with the previously implemented electronic workflow 104-1 (e.g., the checkpoint incident); a threshold time; a distance between the incident and the previous incident; a threshold distance; and respective priorities assigned to the incident and the previous incident. Criteria based on retaining or skipping an overlapping step, which may be stored at the rules 224, are next described.

For example, the controller 220 and/or the computing device 101 may determine a difference between the second time 114-2 and the first time 114-1 and compare the difference to a stored threshold time, which may be any suitable time, and which may be configured at the rules 224 and/or application 223. The threshold time may be determined heuristically and/or using any suitable analytics and/or machine learning algorithms. However, the threshold time may be based on any suitable conditions and/or criteria, and may be any suitable time period below which overlapping steps may be redundant and above which overlapping steps may not be redundant.

In a particular example, the threshold time may comprise a time period between incidents during which it is unlikely that the driver of the vehicle 111 may stop to pick up a suspect and hide the suspect in the trunk of the vehicle 111, such as 5 minutes (e.g. or 15 minutes, or 30 minutes, or any other suitable time period), and the like. Hence, returning to the example of the trunk check steps, when a difference between the second time 114-2 and the first time 114-1 is less than 5 minutes, the controller 220 and/or the computing device 101 may determine that the overlapping step “Check Trunk of Vehicle” is to be omitted from the current electronic workflow 104-2. Conversely, when a difference between the second time 114-2 and the first time 114-1 is greater than (or equal to) 5 minutes (e.g. or 15 minutes, or 30 minutes, or any other suitable time period), the controller 220 and/or the computing device 101 may determine that the overlapping step “Check Trunk of Vehicle” is to be retained at the current electronic workflow 104-2, despite the overlap.

Similarly, the controller 220 and/or the computing device 101 may determine a difference between the locations 113, and compare the difference to a stored threshold distance, which may be any suitable distance, and which may be configured at the rules 224 and/or application 223. The threshold distance may be determined heuristically and/or using any suitable analytics and/or machine learning algorithms. However, the threshold distance may be based on any suitable conditions and/or criteria, and maybe be any suitable distance below which overlapping steps may be redundant and above which overlapping steps may not be redundant.

In a particular example, the threshold distance may comprise a distance between incidents during which it is unlikely that the driver of the vehicle 111 may stop to pick up a suspect and hide the suspect in the trunk of the vehicle 111, such as 500 feet (e.g. or 1 mile or 5 miles, or any other suitable distance), and the like. Hence, returning to the example of the trunk check steps, when a difference between the second location 113-2 and the first location 113-1 is less than 500 feet (feet (e.g. or 1 mile or 5 miles, or any other suitable distance), the controller 220 and/or the computing device 101 may determine that the overlapping step “Check Trunk of Vehicle” is to be omitted from the current electronic workflow 104-2. Conversely, when a difference between the second location 113-2 and the first location 113-1 is greater than (or equal to) 500 feet, the controller 220 and/or the computing device 101 may determine that the overlapping step “Check Trunk of Vehicle” is to be retained at from the current electronic workflow 104-2, despite the overlap.

Similarly, incidents and/or incident types associated with implementation of electronic workflows 104 may be mapped to and/or assigned stored priorities, such as numerical priorities, alphanumeric priorities, and the like, and a determination of whether to retain or omit an overlapping step of the current electronic workflow 104-2 may be based on such priorities. For example overlapping steps of the current electronic workflow 104-2 may be retained or skipped when a priority of one or more incidents associated with the electronic workflows 104-1, 104-2 is greater than a threshold priority and/or meets a threshold condition. Put another way, determining to retain or skip overlapping steps may be based on a priority of one incident, in a pair of incidents. For example, a checkpoint incident (e.g., in searching for a suspect) may be assigned a higher priority than a speeding incident, and the higher priority may be greater than a threshold priority. For example, based on a priority scale of 1 to 10, a checkpoint incident may be assigned a priority of “9” while a speeding incident may be assigned a priority of “5”, and a threshold priority may be set at “8”. In this example, as the priority of the checkpoint incident associated with the previously implemented electronic workflow 104-1 has a priority of “9” that is greater than the threshold priority of “8”, the overlapping “Check Trunk Of Vehicle” step of the current electronic workflow 104-2 may be retained, for example due to the priority in catching the suspect being sought in the checkpoint incident. Such priority may further overrule skipping overlapping steps based on distance and/or time. In yet further examples, the priorities may be alphanumeric-based (e.g., such as “low”, “medium” and “high”) and a threshold criteria for retaining or skipping an overlapping step may include, but is not limited to, a priority having a particular alphanumeric-based priority (e.g., when one of the incidents associated with the electronic workflows 104 has a priority of “high”, an overlapping step may be retained and/or not skipped).

While specific criteria for retaining or skipping overlapping electronic workflow steps are described herein, any suitable criteria for retaining or skipping overlapping steps is within the scope of the present specification. For example, a decision and/or determination to retain or skip overlapping steps may be based on a priority of one incident, in a pair of incidents; however, such a decision and/or determination to retain or skip overlapping steps may be based on a difference between priorities (e.g. a numerical difference between numerical priorities) of a pair of incidents (e.g., associated with a current electronic workflow and a previously implemented electronic workflow). In such an example, when the difference is greater than (or less than) a threshold priority difference, an overlapping step may be retained or skipped, for example. Similarly, priorities may be assigned to given steps of electronic workflows 104 such that certain steps are never skipped, regardless of overlap, while other steps may be skipped when an overlap occurs. Indeed, any suitable criteria for retaining or skipping steps may be configured at the rules 224.

Put another way, the method 300 may include the controller 220 and/or the computing device 101 comparing the one or more overlapping steps with the one or more predetermined rules 224; and in response to determining that a given overlapping step, of the one or more overlapping steps, meets criteria of the one or more predetermined rules 224, at least one of: including the given overlapping step in the current electronic workflow 104-2, and refraining from skipping the given overlapping step.

In response to determining there is no overlap between the remaining steps and the respective executed steps (e.g., a “NO” decision at the block 310), the controller 220 and/or the computing device 101 returns to the block 302 to wait for further search queries.

However, in response to determining an overlap between the remaining steps and the respective executed steps, (e.g., a “YES” decision at the block 310), at a block 312 the controller 220 and/or the computing device 101 causes one or more overlapping steps to be skipped in the current electronic workflow 104-2.

In some examples, to cause one or more overlapping electronic workflow steps to be skipped in the current electronic workflow 104-2, the controller 220 and/or the computing device 101 may transmit, to the user mobile device 103-2, an indication that the one or more overlapping steps in the current electronic workflow 104-2 are to be skipped. For example, such an indication may comprise text such as “Permission To Skip Check Trunk of Vehicle Step” and/or “This Vehicle Was Recently Stopped: The Trunk Was Checked, And Was Empty And Hence You May Skip The Check Trunk Of Vehicle Step”, and the like. In some examples, the indication may be more specific and electronically indicate that that the one or more overlapping steps were completed in a previously implemented electronic workflow 104-1 along with additional contextual information regarding the previous electronic workflow; for example, such an indication may comprise text such as “This Vehicle Was Stopped 4 Minutes Ago And A Checkpoint Electronic Workflow Was implemented; The Trunk Was Checked, And Was Empty And Hence You May Skip The Check Trunk Of Vehicle Step”.

The indication may yet be more specific; for example, such an indication may comprise text such as “This Vehicle Was Stopped 4 Minutes Ago In A Checkpoint Incident Searching For A Suspect, And A Checkpoint Electronic Workflow Was Implemented; The Trunk Was Checked, And Was Empty And Hence You May Skip The Check Trunk Of Vehicle Step”; such an indication may further include, but is not limited to, electronically captured and stored media from the prior workflow step being skipped, such as a photograph, and the like, of a suspect being sought in the checkpoint incident.

Hence, the method 300 may further comprise the controller 220 and/or the computing device 101 providing, to the user mobile device 103-2, a notification of one or more of: the previously implemented electronic workflow 104-1; and a previous incident associated with the previously implemented electronic workflow 104-1, and/or a time and/or location at which the previously implemented electronic workflow 104-1 was implemented.

In yet further examples, the indication may include content for populating a field of an overlapping step of the current electronic workflow 104-2. For example, the content 119 of “Empty” may be transmitted to the mobile device 103-2, which may be used to populate the field 139 of the overlapping “Check Trunk Of Vehicle Step”. Put another way, electronic content (e.g. text, media, and the like) of a field associated with previously executed respective step of the previously implemented electronic workflow 104-1 may be transmitted to the mobile device 103-2 to populate a corresponding field of the overlapping step of the current electronic workflow 104-2.

In further examples, to cause one or more overlapping steps to be skipped in the current electronic workflow 104-2, the controller 220 and/or the computing device 101 may transmit, to the user mobile device 103-2, a modified electronic workflow 104 comprising the current electronic workflow 104-2 with the one or more overlapping steps omitted. For example, a modified electronic workflow 104 may include steps “1” and “3” of the current electronic workflow 104-2, with a field for the license plate number already populated based on the search query 149, but omit step “2”. In yet further examples, the modified electronic workflow may include text indicative of an overlapping step that is to be skipped (e.g., and/or greyed out and the like), and the like, and/or with a corresponding field (e.g., the field 139) populated.

In yet further examples, to cause one or more overlapping steps to be skipped in the current electronic workflow 104-2. the controller 220 and/or the computing device 101 may store, at one or more memories (e.g., such as the memory 107 and/or another memory accessible to the mobile device 103-2, via a network, and/or communication link) one or more of the indication, as described above, and the modified electronic workflow, as described above, for retrieval by the user mobile device 103-2, thereby causing the user mobile device 103-2 to skip the one or more overlapping steps.

For example, as described above, after the search query 149 is transmitted, the mobile device 103-2 may query the memory 107 and/or any suitable memory, for the indication and/or the modified electronic workflow and retrieve the indication and/or the modified electronic workflow for processing, which results in the mobile device 103-2 skipping the overlapping steps. Hence, such storing of the indication and/or the modified electronic workflow by the computing device 101 causes the overlapping steps to be skipped.

The method 300 may include the controller 220 and/or the computing device 101 implementing any other suitable features.

For example, the method 300 may further comprise the controller 220 and/or the computing device 101 adding a further step to the current electronic workflow 104-2 based on one or more of: a time between the incident and a previous incident associated with the previously implemented electronic workflow 104-2; a threshold time; a distance between the incident and the previous incident; a threshold distance; and respective priorities assigned to the incident and the previous incident.

Time, distance and/or priority based retention or skipping of overlapping steps was described above. Similar criteria may be used to add a given step to the current electronic workflow 104-2. For example, based on a time difference and/or distance difference between the electronic workflows 104-1, 104-2, and/or priorities of the electronic workflows 104-1, 104-2, the current electronic workflow 104-2 may be modified to include an additional step. For example, the vehicle 111 may be caught speeding away from the location 113-1 of the checkpoint incident (e.g., which may have a priority that exceeds a threshold priority), for example within a threshold time period and/or within a threshold distance from the location 113-1. In some examples, the current electronic workflow 104-2 (e.g., the speeding electronic workflow 104-2) may be modified to include a step of the user 105-2 asking a reason for the speeding, and/or performing a stricter search of the vehicle 111 and/or occupants of the vehicle 111 and/or the location 113-2 of the vehicle 111 (e.g., such as more thorough trunk check that includes looking in a wheel storage area, and/or an undercarriage check, and/or a chassis check, and/or a backseat check and/or under-seat check and/or a glove compartment check, a body check (e.g., frisking) of the occupants, and the like, and/or a search of areas adjacent the location 113-2 where a suspect may hide close to the vehicle 111, such as a dumpster and/or a doorway, and the like).

Hence, in some of these examples, the controller 220 and/or the computing device 101 may add a further step to the current electronic workflow 104-2 based on time and/or distance and/or priority. As described above the further step comprising: instructions to perform a stricter check of one or more of a person, an object and a location associated with an incident, than is performed in the steps of the current electronic workflow 104-2.

In some examples, the addition of additional given steps to an electronic workflow 104 may be based on other criteria (e.g., of the rules 224). For example, the method 300 may further comprise the controller 220 and/or the computing device 101 determining that the current electronic workflow 104-2 has been implemented more than a threshold number of times within a given time period. Put another way, the vehicle 111 may have been caught speeding more than a threshold number of times within a given time period (e.g., such as 3 times within an hour and/or any other suitable number of times within any other suitable time period). In response, the controller 220 and/or the computing device 101 may adding a further step to the current electronic workflow 104-2, the further step comprising: instructions to perform a stricter check of one or more of a person, an object and a location associated with the incident, than is performed in the steps of the current electronic workflow 104-2, as described above. For example, the driver of the vehicle 111 may be repeatedly attempting leave an area quickly due to malicious reasons, and hence stricter check of the vehicle 111, and the like, may be implemented.

In other examples, however, a determination that the current electronic workflow 104-2 has been implemented more than a threshold number of times within a given time period may not be specific to the vehicle 111, and the like, and may be based on a number of times that the current electronic workflow 104-2 was implemented independent of which vehicles 111, and the like, were caught speeding. For example, many vehicles caught speeding in a given area, in a given time period, may be indicative of on-going malicious activity (e.g., such as street racing) and hence stricter checks of vehicles, and the like, may be implemented.

While stricter checks were described with respect to implementation of speeding electronic workflows 104, it is understood that stricter checks may occur when other types of electronic workflows 104 are implemented more than a threshold number of times within a threshold time period; for example, a given vehicle being stopped at checkpoints more than a threshold number of times within a threshold time period may indicate the given vehicle is attempting to quickly traverse an area that includes the checkpoints, which again may indicate malicious activity; hence a stricter check of the given vehicle, and the like, may be implemented.

In some examples, the method 300 may further include the controller 220 and/or the computing device 101 storing, at the memories (e.g., the memory 107), in association with the current electronic workflow 104-2: the search query 149; and respective content of one or more of the respective executed steps of the previously implemented electronic workflow 104-1 that overlaps with the one or more overlapping steps. Put another way, the controller 220 and/or the computing device 101 may store, at the memory 107, and the like, content associated with the current electronic workflow 104-2, whether collected during implementation of the current electronic workflow 104-2, a modified version thereof and/or collected during implementation of the previously implemented electronic workflow 104-1. As such, the controller 220 and/or the computing device 101 may reimplement the method 300 in future implementation of electronic workflows 104 using the content 109 and the content associated with the current electronic workflow 104-2. In some of these examples, content stored in association with the current electronic workflow 104-2, but which was collected in the previously implemented workflow 104-1, may be further associated with the previously implemented workflow 104-1 when stored.

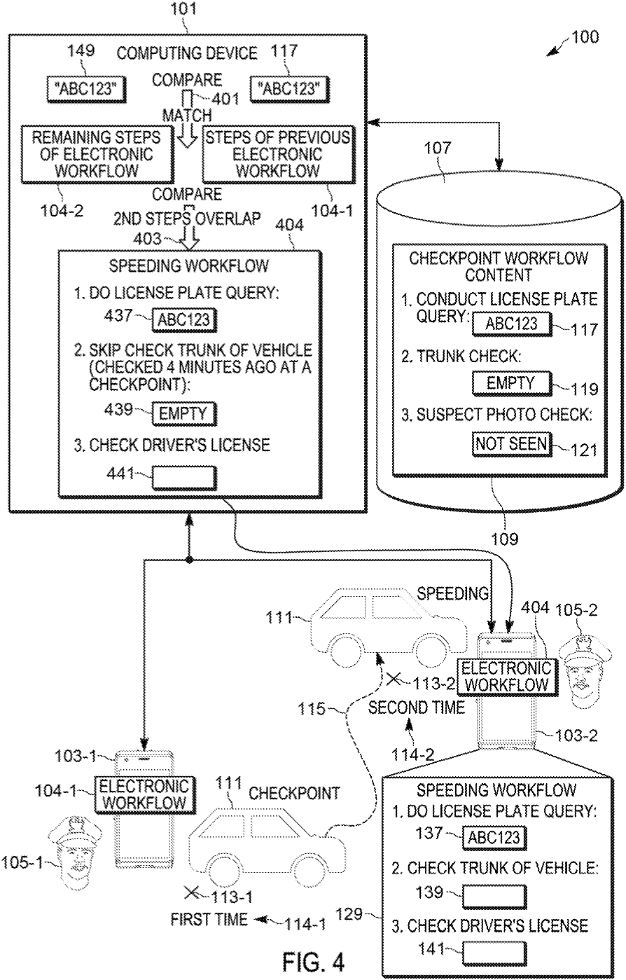

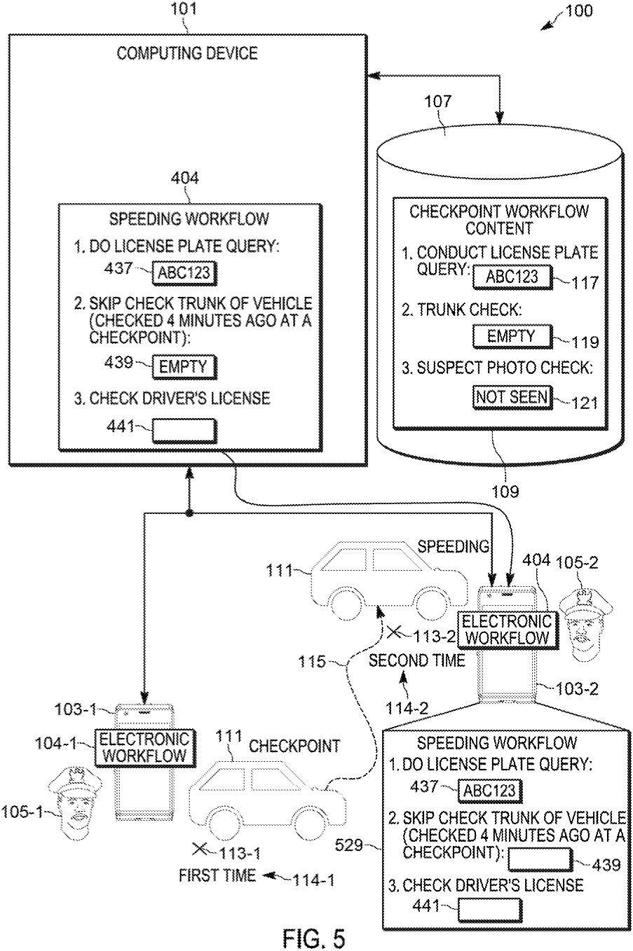

Attention is next directed to FIG. 4 and FIG. 5, which depict an example of the method 300 being implemented at the computing device 101. FIG. 4 and FIG. 5 are similar to FIG. 1 with like components having like numbers.

With attention first directed to FIG. 4 it is understood that the computing device 101 has received (e.g., at the block 302 of the method 300), the search query 149 of the current electronic workflow 104-2, and is comparing (e.g., at the block 302 of the method 300) the search query 149 with the content 117 of a stored search query of the previously implemented electronic workflow 104-1. As depicted, the computing device 101 determines that the search query 149 and the content 117 of a stored search query match (e.g., a “YES” decision at the block 306 of the method 300), as indicated by an arrow 401 labelled “MATCH”.

In response to determining that the search query 149 and the content 117 of a stored search query match, the computing device 101 compares (e.g., at the block 308 of the method 300) remaining steps of the current electronic workflow 104-2 with steps of the previously implemented electronic workflow 104-1.

As depicted, the computing device 101 determines that the second steps of the workflows 104-1, 104-2 (e.g.. the trunk check steps, as described above) overlap (e.g., a “YES” decision at the block 310 of the method 300), as indicated by the arrow 403 labelled “2nd Steps Overlap”.

In response to determining that the second steps of the workflows 104-1, 104-2 overlap, the computing device 101 generates a modified electronic workflow 404 comprising the current electronic workflow 104-2 with an indication that the overlapping “Check Trunk Of Vehicle” step is to be skipped. For example, as depicted, the “Check Trunk Of Vehicle” step is modified to include the word “SKIP” as well as an indication that the trunk of the vehicle 111 was “Checked 4 Minutes Ago At A Checkpoint”. Furthermore, the modified electronic workflow 404 includes a field 437 corresponding to the field 137 of the current electronic workflow 104-2, and populated with the license plate number received in the search query 149. Similarly, the modified electronic workflow 404 includes a field 439 corresponding to the field 139 of the current electronic workflow 104-2, and populated with the content 119 of the previously implemented electronic workflow 104-1, which may also cause the overlapping “Check Trunk Of Vehicle” step to be skipped. Similarly, the modified electronic workflow 404 includes a field 441 corresponding to the field 141 of the current electronic workflow 104-2, and which is unpopulated as the third step of the current electronic workflow 104-2 does not overlap with previously executed steps of the previously implemented electronic workflow 104-1.

Attention is next directed to FIG. 5, which depicts the computing device 101. response to determining that the second steps of the workflows 104-1, 104-2 overlap, causing (e.g., at the block 312 of the method 300) to skip the overlapping “Check Trunk Of Vehicle” step by transmitting the modified electronic workflow 404 to the mobile device 103-2. When the mobile device 103-2 receives the modified electronic workflow 404, the mobile device 103-2 replaces the window 129 (e.g., at a display screen of the mobile device 103-2) with the window 529 that includes the steps and fields 437, 439, 441 of the modified electronic workflow 404. As such, the user 105-2 skips the overlapping “Check Trunk Of Vehicle” step, thereby saving processing resources at least at the mobile device 103-2. The user 105-2 may then perform a driver’s license check to complete the modified electronic workflow, 404.

As mentioned above, while present examples are described with respect to public safety electronic workflows 104, in other examples the method 300, and the like may be used to skip overlapping steps of other types electronic workflows. For example, the method 300 may be implemented in warehouse computing device to skip warehousing steps of warehouse electronic workflows. For example, two warehouse electronic workflows (e.g., an inventory workflow and a goods pick up workflow), being implemented at warehouse mobile devices, may include a “disinfect item” step, and the like. In a particular example, a first warehouse electronic workflow may have been implemented that included a barcode search query step for an item, and a disinfect item step. Later, a second warehouse electronic workflow (e.g., different from the first electronic workflow) may be implemented that also includes barcode search query step, and a disinfect item step. A warehouse computing device may cause the disinfect step to be skipped in the second warehouse electronic workflow on the basis of barcode search queries for the item being matched, and the disinfect step having been already performed at the first warehouse electronic workflow.

For example, the method 300 may be implemented in hotel computing device to skip hotel-related steps of hotel electronic workflows. For example, two hotel electronic workflows (e.g., a repair work-flow and a room cleaning workflow), being implemented at hotel mobile devices, may include a “clean bathtub” step, and the like. In a particular example, a first hotel electronic workflow may have been implemented that included a room number search query step, and a clean bathtub step. Later, a second hotel electronic workflow (e.g.. different from the first electronic workflow) may be implemented that also includes room number search query step, and a clean bathtub step. A hotel computing device may cause the clean bathtub step to be skipped in the second hotel electronic workflow on the basis of room number search queries for a room (e.g., being repaired and then cleaned) being matched, and the clean bathtub step having been already performed at the first hotel electronic workflow.

As should be apparent from this detailed description above, the operations and functions of computing devices described herein are sufficiently complex as to require their implementation on a computer system, and cannot be performed, as a practical matter, in the human mind. Computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In this document, language of “at least one of X, Y, and Z” and “one or more of X, Y and Z” may be construed as X only, Y only, Z only, or any combination of two or more items X, Y, and Z (e.g., XYZ, XY, YZ, XZ, and the like). Similar logic may be applied for two or more items in any occurrence of “at least one ...” and “one or more...” language.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes” “including,” “contains”. “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ...a”, “has ...a”, “includes ...a”, “contains ...a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method comprising:
receiving, at a computing device, from a user mobile device, a search query, as one step, of a plurality of steps, of a current electronic workflow followed in association with an incident;
comparing, via the computing device, the search query with stored search queries received from other user mobile devices as a respective step of previously implemented respective electronic workflows, different from the current electronic workflow, as stored at one or more memories;
in response to matching the search query with a stored search query of a previously implemented electronic workflow, comparing, via the computing device, remaining steps of the current electronic workflow with respective executed steps of the previously implemented electronic workflow; and,
in response to determining an overlap between the remaining steps and the respective executed steps, causing, via the computing device, one or more overlapping steps to be skipped in the current electronic workflow.

2. The method of claim 1, wherein causing the one or more overlapping steps to be skipped in the current electronic workflow comprises one or more of:
transmitting, from the computing device, to the user mobile device, an indication of one or more of: the one or more overlapping steps in the current electronic workflow are to be skipped; and that the one or more overlapping steps were completed in the previously implemented electronic workflow;
transmitting, from the computing device, to the user mobile device, a modified electronic workflow comprising the current electronic workflow with the one or more overlapping steps omitted; and
storing, at the one or more memories, one or more of the indication and the modified electronic workflow for retrieval by the user mobile device, thereby causing the user mobile device to skip the one or more overlapping steps.

3. The method of claim 1, further comprising providing, to the user mobile device, a notification of one or more of: the previously implemented electronic workflow; and a previous incident associated with the previously implemented electronic workflow.

4. The method of claim 1, wherein comparing the search query with the stored search queries comprises:
determining whether content of the search query matches respective content of the stored search queries.

5. The method of claim 1, wherein determining the overlap between the remaining steps and the respective executed steps comprises one or more of:
determining that the one or more overlapping steps are duplicates of one or more of the respective executed steps; and
determining that the one or more overlapping steps are an equivalent of one or more of the respective executed steps.

6. The method of claim 1, further comprising determining whether to retain or skip the one or more overlapping steps based on one or more of:
a time between the incident and a previous incident associated with the previously implemented electronic workflow;
a threshold time;
a distance between the incident and the previous incident;
a threshold distance; and
respective priorities assigned to the incident and the previous incident.

7. The method of claim 1, further comprising:
comparing the one or more overlapping steps with one or more predetermined rules; and
in response to determining that a given overlapping step, of the one or more overlapping steps, meets criteria of the one or more predetermined rules, at least one of:
including the given overlapping step in the current electronic workflow; and
refraining from skipping the given overlapping step.

8. The method of claim 1, further comprising adding a further step to the current electronic workflow based on one or more of:
a time between the incident and a previous incident associated with the previously implemented electronic workflow;
a threshold time:
a distance between the incident and the previous incident;
a threshold distance; and
respective priorities assigned to the incident and the previous incident.

9. The method of claim 1, further comprising:
determining that the current electronic workflow has been implemented more than a threshold number of times within a given time period; and, in response,
adding a further step to the current electronic workflow, the further step comprising: instructions to perform a stricter check of one or more of a person, an object and a location associated with the incident, than is performed in the steps of the current electronic workflow.

10. The method of claim 1, further comprising:
storing, at the one or more memories, in association with the current electronic workflow: the search query; and respective content of one or more of the respective executed steps of the previously implemented electronic workflow that overlaps with the one or more overlapping steps.

11. A device comprising:
a communication unit configured to communicate with user mobile devices;
a controller communicate coupled to the communication unit and one or more memories, controller configured to:
receive, via the communication unit, from a user mobile device, a search query, as one step, of a plurality of steps, of a current electronic workflow followed in association with an incident;
compare the search query with stored search queries received from other user mobile devices as a respective step of previously implemented respective electronic workflows, different from the current electronic workflow, as stored at the one or more memories;
in response to matching the search query with a stored search query of a previously implemented electronic workflow, compare remaining steps of the current electronic workflow with respective executed steps of the previously implemented electronic workflow; and,
in response to determining an overlap between the remaining steps and the respective executed steps, cause one or more overlapping steps to be skipped in the current electronic workflow.

12. The device of claim 11, wherein the controller is further configured to cause the one or more overlapping steps to be skipped in the current electronic workflow by one or more of:
transmitting, via the communication unit, to the user mobile device, an indication of one or more of: the one or more overlapping steps in the current electronic workflow are to be skipped; and that the one or more overlapping steps were completed in the previously implemented electronic workflow;
transmitting, via the communication unit, to the user mobile device, a modified electronic workflow comprising the current electronic workflow with the one or more overlapping steps omitted; and
storing, at the one or more memories, one or more of the indication and the modified electronic workflow for retrieval by the user mobile device, thereby causing the user mobile device to skip the one or more overlapping steps.

13. The device of claim 11, wherein the controller is further configured to provide, via the communication unit, to the user mobile device, a notification of one or more of: the previously implemented electronic workflow; and a previous incident associated with the previously implemented electronic workflow.

14. The device of claim 11, wherein the controller is further configured to compare the search query with the stored search queries by:
determining whether content of the search query matches respective content of the stored search queries.

15. The device of claim 11, wherein the controller is further configured to determine the overlap between the remaining steps and the respective executed steps by one or more of:
determining that the one or more overlapping steps are duplicates of one or more of the respective executed steps; and
determining that the one or more overlapping steps are an equivalent of one or more of the respective executed steps.

16. The device of claim 11, wherein the controller is further configured to determine whether to retain or skip the one or more overlapping steps based on one or more of:
a time between the incident and a previous incident associated with the previously implemented electronic workflow;
a threshold time;
a distance between the incident and the previous incident;
a threshold distance; and
respective priorities assigned to the incident and the previous incident.

17. The device of claim 11, wherein the controller is further configured to:
compare the one or more overlapping steps with one or more predetermined rules; and
in response to determining that a given overlapping step, of the one or more overlapping steps, meets criteria of the one or more predetermined rules, at least one of:
include the given overlapping step in the current electronic workflow; and
refrain from skipping the given overlapping step.

18. The device of claim 11, wherein the controller is further configured to add a further step to the current electronic workflow based on one or more of:
a time between the incident and a previous incident associated with the previously implemented electronic workflow;
a threshold time;
a distance between the incident and the previous incident;
a threshold distance; and
respective priorities assigned to the incident and the previous incident.

19. The device of claim 11, wherein the controller is further configured to:
determine that the current electronic workflow has been implemented more than a threshold number of times within a given time period; and, in response,
add a further step to the current electronic workflow, the further step comprising: instructions to perform a stricter check of one or more of a person, an object and a location associated with the incident, than is performed in the steps of the current electronic workflow.

20. The device of claim 11, wherein the controller is further configured to:
store, at the one or more memories, in association with the current electronic workflow: the search query; and respective content of one or more of the respective executed steps of the previously implemented electronic workflow that overlaps with the one or more overlapping steps.
